(19) United States
(12) Patent Application Publication
(10) Pub. No.: US 2014/0244351 A1
(43) Pub. Date: Aug. 28, 2014

(54) CUSTOMER RELATIONSHIP MANAGEMENT (CRM) SYSTEMS

(71) Applicant: Single Funnel Pty Ltd, Surry Hills (AU)

(72) Inventor: Matthew John Symons, Sydney (AU)

(73) Assignee: Single Funnel Pty Ltd, Surry Hills (AU)

(21) Appl. No.: 14/192,692

(22) Filed: Feb. 27, 2014

Related U.S. Application Data
(60) Provisional application No. 61/770,788, filed on Feb. 28, 2013.

(51) Int. Cl. G06Q 30/02; G06F 17/30

(52) U.S. Cl. CPC G06Q 30/0201; G06F 17/30091
USPC 705/7.29

(57) ABSTRACT

A customer, prospect and campaign management system maintains a single view of customers in one unified funnel, allowing companies to share platform-based, single-funnel views of prospects and customers in a privacy-compliant networked system. Individual customer relationship data records can be shared in a distributed multi-master, multi-slave or peer-peer context, partially or fully anonymously by removal of personally identifiable information, to one or more distributed slave or peer CRM systems. Anonymous data records in the slave or peer CRM systems may be used to select, target and track customers through a customer relationship funnel for communications using one or more communication proxies. Target customers may be advanced within the master, slave or peer CRM funnels and, given appropriate customer permission, the customer record may be identified fully or partially.

### RELATED APPLICATIONS

This application claims the benefit of and priority to U.S. Provisional Application Ser. No. 61/770,788, filed Feb. 28, 2013, the contents of which are hereby incorporated by reference as if recited in full herein for all purposes.

### BACKGROUND

This application pertains generally to aspects of customer relationship management, data warehousing, propensity modelling and marketing automation to provide a simple, scalable marketing system for addressable media and digital advertising that facilitates discriminating customers, determining next best offers and delivering tailored messages.

This application also relates to a distributed multi-master multi-slave or peer to peer customer relationship management system, and more specifically, but not exclusively, to a networked system where customer relationship data records can be shared in a distributed multi-master multi-slave or peer-to-peer context maintaining partially or fully anonymous customer data state.

This application also discloses innovative aspects of fields such as but not limited to Computer Telephony Integration (CTI), digital advertising, federated identity, cryptography, cloud services and Software as a Service (SaaS)/Platform as a Service (PaaS) and related fields.

Customer Relationship management (CRM) systems were originally developed around significantly dedicated and internally hosted servers and software for the tracking of customers in Relational Database Management Systems (RDBMS). Recent CRM systems, such as Salesforce, now allow considerable flexibility in the distributed and automated management of customer relationship data records as Software as a Service (SaaS) within a cloud service environment.

Currently available CRM systems, however, still utilise simple RDBMS technology stacks which whilst perhaps sufficient for individual corporations or hierarchies of organisations, suffer from considerable limitations when attempting to share or utilise customer relationship data records between or among commercial entities in a secure fashion while pursuing often competing commercial, privacy and compliance objectives.

Furthermore current systems often suffer from a fragmentation of data storage, purpose and siloed operational use. For instance, existing businesses tend to organise customer data into three main data activities:
1. CRM data warehouses for long term management of customer data,
2. Prospect data marts for management of research and modelling and
3. Campaign specific databases for tracking and reporting on campaign activity

Because such stores tend to be operated by different teams and sometimes different departments, problems of solution and data integrity inevitably arise. Most large enterprises find it almost impossible to attain a single view of their customers, most compromising for a holistic view of customer and most of these views being tenuous at best. Such inability to accurately view one's customers and their relationship with the business can create friction and waste in customer-relations operations such as service, sales and marketing. As a result, customer experience with companies can be frustrating due to time of service for duplicate entry and repeat calls to resolve the same problem in multiple systems.

In addition, due to the complexity of CRM operations such as but not limited to sales force management, prospect management, campaign management, customer service & support, scheduling & calendaring, analytics, modelling & reporting and loyalty/retention, CRM systems tend to be beyond the reach of most small to medium sized business skill sets. Even free or open source systems have poor uptake leaving most businesses without CRM capabilities beyond book keeping applications and contact management applications. Such basic systems are often inadequate for dealing with the breadth of complex functions listed above and being completely inadequate in dealing with the recent rise in usage of social media as a market-place tool.

Further difficulties arise around ethics, privacy and security when businesses want to collaborate or share data. Certain geographic regions have prohibitive privacy and security legislation that makes such collaboration virtually impossible. Smaller or starting businesses therefore struggle to generate the initial volume of customer data with which to make CRM systems cost effective. Furthermore, generation of prospects and leads can be prohibitively expensive for these businesses and so they tend to focus on less effective marketing cost models like sponsorship and broad reach product marketing such as yellow pages directories and broadcast radio.

Currently available CRM systems do not effectively operate in a network of untrusted business-business (B2B) and multiple businesses sharing a single customer view domain.

Thus, there remains a need for improved CRM systems.

### SUMMARY

Presently disclosed systems satisfy the aforementioned and/or other needs of the prior art. For example, by integrating the disparate customer, prospect and campaign data sources and overlaying the unified data with a simplified management framework as disclosed herein that abstracts and conceals the deeper operating complexity of such marketing systems, some disclosed CRM systems can effectively place all customer, prospect and campaign data in one unified funnel, including:
Existing customers
Purchased prospects
Anonymous audience segments (or look-a-likes)
Channel specific audiences

One or more of the foregoing features can be offered in a platform as a service (sometimes referred to in the art as a “PaaS”) model adapted to allow one or more businesses to plugin for marketing automation and “dial up” customer and revenue growth without investing in complex, bespoke (e.g., “custom”) marketing systems or needing to understand the technical aspects of marketing to operate a marketing based growth strategy.

For larger businesses disclosed systems can remove legacy overhead, siloed data and functions, and transactional friction in conducting marketing operations.

For smaller to medium businesses disclosed systems can give a simple action directive to staff, such as “this week, target these people, with these offers on these channels” and execution capability. This can effectively offer a “marketing in a box” or “marketing as a service” capability for small to medium businesses for a range of commercial models including but not limited to a flat monthly subscription cost, a pay per lead/acquisition model or a hybrid of the two.

From a business perspective disclosed systems are perceived as one simple, unified environment having campaign, marketing, sales and customer relationship management functions.

As but one example of disclosed functionality, FIG. 1 illustrates a user interface (sometimes referred to in the art as a “screen”) showing a summary of business goals and a suggested best set of actions to take to grow customer numbers, revenue, retention/loyalty and/or a number of other objectives. Such actions may be high value bottleneck actions such as:
Concentrate on outbound calls
Buy or grow more prospects
Close outstanding sales.

Alternatively, such action may be finer grained actions based on individual priorities such as:
The next most profitable offer for this customer/prospect is a 10% discount on next purchase within 48 hours.

As another example, a screen can allow a business owner to build one or more prospect lists either automatically or manually based on a number of criteria specific to the operational nature of the business or industry vertical. Such a system can support prospect development based on “look-a-like” segmentation of audience based on historical success data including CRM data.

With systems and methods disclosed herein, a user may easily visualise individual or group details about their customers to enable more successful customer interactions and communications. Such information can be stored in a single, unified data store.

Some disclosed systems can show, as in FIG. 2, who a business's customers and prospects are by a range of attributes including but not limited to demographics, segmentation, behaviour, timing, household information, locations (current and visited), life events, social triggers and purchase history.

Some disclosed systems can show likely prospects and scores them on their propensity to convert.

Some disclosed systems can integrate with research, analyst and business intelligence sources by business category.

In some disclosed systems, all customer, prospect and campaign data are stored in one unified data source.

As shown in FIG. 3, a screen can allow a business owner to manually or automatically execute a range of marketing functions based on a defined set business goals, existing customers and any given prospect lists. Some disclosed systems can support a template and/or a dynamic campaign, wizard, or other automation to easily handle such campaign forms as sales/offers and calendar events like birthdays/holidays. Some disclosed systems can automatically build campaigns based on but not limited to:
Businesses segment (such as ANZSIC code, industry/business vertical type)
Category/keyword taxonomies (such as AdWords keyword families/hierarchies)
Channel specific details (such as device resolution, internet bandwidth, geo-location)

Some disclosed systems can report on traceable marketing activity across all campaign channels by individual or segmented prospect or customer views.

Some disclosed systems can calculate and/or track marketing attribution pathways through the funnel to point and mechanism of purchase.

Some disclosed systems can show target audience behaviour by intelligence source, prospect attributes, channel characteristics, lead effectiveness, sales effectiveness and many other measurement mechanisms.

A screen, as shown in FIG. 4, can function as a simple customer relationship management source allowing a user to easily visualise individual or group details about their customers to enable more successful customer interactions and communications.

A user can view customer details, purchase history, service history by drilling down into the appropriate section of the funnel or by searching for a customer by name or for groups of customers by demographics, segmentation, behaviour, date/time, household attributes, location, life events, social triggers, purchase history etc.

Some disclosed systems can utilise existing sources of data or build its own through regular operation. It does so through a data import capability in the business profile set up section of the application.

Some disclosed systems can match anonymous system identifiers to partner business CRM identifiers. Some disclosed systems can match anonymous system identifiers to registered 3rd party login identifiers. Some disclosed systems can match anonymous system identifiers to device identifiers such as IMEI, Apple's IDFA, Google's AdvertiserID, subscriber ID. Some disclosed systems can match anonymous system identifiers to IP Addresses on a time window or access time basis. Some disclosed systems can match anonymous system identifiers to device fingerprints such as those provided by AdTruth. Some disclosed systems can match anonymous system identifiers to behavioural contexts or profiles such as those provided by DrawBirdge.

Some disclosed systems can show CRM, prospect and campaign information in a unified funnel.

Some disclosed systems can integrate with and/or import existing system data from such systems as book keeping applications such as MYOB, Zero, Easy Books etc as well as CRM systems such as SugarCRM, Salesforce, Siebel, Microsoft Dynamics etc as well as social media applications such as Facebook, Twitter, LinkedIn, Pinterest etc.

Some disclosed systems can understand and can store social graph data such as friends, friends of friends, family, extended family and no relationship. Such a system can store and understands influence scores such as Klout, Kred and networked influence affects.

Some disclosed systems can be powered by a simple revenue promise where target customers might opt in for offers/discounts or be targeted based on historical products and services with a particular Business-And an extension of those services through such an existing client-service relationship.

Some disclosed systems can allow more than one company to share this platform-based, single funnel view of prospects and customers and that each company may collaborate in offering complimentary sets of services to the shared funnel while only having full visibility of their own customers.

Some disclosed systems are capable of storing and processing the population of entire suburbs/cities, states, nations or the entire world in a single funnel view.

Some disclosed systems support a veiled view of unknown/anonymous prospects and customers whereby privacy and data security is ensured but whereby certain levels of activity may unlock prospect/customer profile information if a prospect or customer interacts sufficiently with a business. The operating complexity of marketing systems can be abstracted and concealed from the operator.

By allowing multiple businesses to privately and securely share prospect and customer data, disclosed methods and systems allow businesses to grow much faster than they might otherwise.

By allowing multiple businesses to privately and securely share a single funnel view of these prospects, trigger events, life stage and contact rules based marketing can be executed much more effectively than if each business maintained their own data stores and systems.

Some disclosed systems are capable of deriving meaning from actions in one subset of the global data to privately and securely update prospects or intelligence to another business subset of the global data.

Some disclosed systems can calculate, by business, what is meaningful, worthy, substantial or profitable in a business subset of the data based on private and secure global view of the data.

Some disclosed systems can build prospect lists either automatically or manually based on a number of criteria specific to the operational nature of the business or industry vertical. Some disclosed systems are configured to summarize a suggested next set of actions to take to grow customer numbers, revenue, retention/loyalty or any number of other business objectives may be generated automatically based on a range of prospect, campaign and/or customer data. Some disclosed system are configured to show who a business's customers and prospects are by a range of attributes including but not limited to demographics, segmentation, behaviour, timing, household information, locations (current and visited), life events, social triggers and purchase history.

Some disclosed systems show likely prospects and scores them on their propensity to convert. Some disclosed systems integrate with research, analyst and business intelligence sources by business category. Some disclosed systems allow a business owner to manually or automatically execute a range of marketing functions based on the set business goals, existing customers and any given prospect lists.

Some disclosed systems support template and dynamic campaigns, wizards and automation to easily handle such campaign forms such as sales/offers and calendar events such as birthdays/holidays.

Some disclosed systems can automatically build campaigns based on businesses segment such as ANZSIC code, industry/business vertical type etc.

Some disclosed systems can automatically build campaigns based on category/keyword taxonomies such as AdWords keyword families/hierarchies etc

Some disclosed systems can automatically build campaigns based on channel specific details such as payment plan, device resolution, internet bandwidth, geo-location.

Some disclosed systems report on traceable marketing activity across all campaign channels by individual or segmented prospect or customer views.

Some disclosed systems calculate and track marketing attribution pathways through the funnel to points and mechanisms of purchase.

Some disclosed systems show target audience behaviour by intelligence source, prospect attributes, channel characteristics, lead effectiveness, sales effectiveness and many other measurement mechanisms.

Some disclosed distributed customer relationship management (CRM) networks allow individual customer data records to be shared between multiple businesses' CRM systems. In some instances, the distributed customer relationship management (CRM) network which allows individual customer data records to be shared between multiple businesses' CRM systems may do so whilst preserving the privacy of the individual customers. In some instances, the distributed customer relationship management (CRM) network operates in a master-slave embodiment. In some instances, the distributed customer relationship management (CRM) network operates in a master-multi-slave or hub and spoke embodiment.

In some instances, the distributed customer relationship management (CRM) network operates in a multi-master-multi-slave embodiment.

In some instances, the distributed customer relationship management (CRM) network operates in a peer-peer embodiment.

In some instances, the distributed customer relationship management (CRM) network makes use of one or more cryptographic systems for making customer data records effectively anonymous between several parties but retains the capability to identify individual records within itself.

In some instances, the distributed customer relationship management (CRM) network makes use of one or more content generation engines that may generate communication content such as service messages, emergency messages or marketing communications tailored to an individual or group of individuals sharing one or more characteristics without divulging personal information.

In some instances, the distributed customer relationship management (CRM) network makes use of one or more data transfer mechanisms to transfer customer data records and or communication content effectively anonymous between several parties but retains the capability to identify individual records or communications within itself.

In some instances, the distributed customer relationship management (CRM) network makes use of one or more communication proxies that allows direct communication with individual customers without divulging personal information.

In some instances, the distributed customer relationship management (CRM) network may utilise anonymous customer data in a marketing and/or modelling and/or analytics system to segment, target, track and report on communications without divulging personally identifiable information regarding the customer.

In some instances, the distributed customer relationship management (CRM) network may allow customers who progress fully to becoming customers of an anonymous CRM operator to be identified by the permission of the customer or some other entity with permission to do so, such as a corporation who has elicited permission to market products or services of itself and its partners to its customers.

In some instances, the distributed customer relationship management (CRM) network may add or remove customer data from a slave CRM system for a variety of commercial or compliance or legal purposes.

Some disclosed systems can generate anonymous session or interaction based identifiers in such a way as to prevent collusion between businesses or even a single business executing repeat engagements from identifying or mining data from the system beyond a single engagement contextSome disclosed systems provide a network of one or more master and one or more slave CRM systems, including:
a network of one or more databases for storing customer relationship data records and in each case their state within a customer journey funnel;
an allocation tool for associating various customer relationship data records in one or more master or peer CRM systems with one or more customer relationship data records within one or more slave or peer CRM systems; and
a cryptographic engine for masking or making anonymous certain personal data pertaining to the customer relationship data record so it may persist from the network of master CRM systems to the network of slave CRM systems without betraying its full identity.

Also disclosed is a communication engine system having:
a data manager for tracking individual customer relationship management communications and targets and processing rules for determining a propensity model for future communications;
a content generation engine for processing customer relationship data records and the referenced propensity models to access content items and generate a plurality of communication media for communication to a target customer.

### BRIEF DESCRIPTION OF THE DRAWINGS

Embodiments of the disclosed innovations are hereinafter described, by way of example only, with reference to the accompanying drawings, wherein:

FIG. 1 illustrates a representative user interface showing a summary of CRM system status and suggested actions.

FIG. 2 illustrates a representative user interface showing options for a user to build prospect lists based on selected business-relevant criteria.

FIG. 3 illustrates a representative user interface showing options for a user to perform one or more selected marketing functions.

FIG. 4 illustrates a representative user interface summarizing customer ratings using a plurality of units of measure.

FIG. 5 is a schematic of a preferred embodiment of a privacy compliant, distributed customer relationship management (CRM) network where Business-A with little or no existing CRM capability or customer data assets wishes to utilise the CRM and data assets of Business-B without investing in, purchasing or licensing their own CRM system or acquiring their own data asset. This embodiment may be run with multiple slave businesses, each licensing their own separate slave context from Business-B. In this embodiment slave contexts are held in individual tenancy arrangements for privacy, compliance, legal, business or customer experience reasons.

FIG. 6 is a schematic illustration of an embodiment of a privacy-compliant, distributed customer relationship management (CRM) network in which Business A wishes to license its CRM system and data records to one or more businesses, in a secure, shared tenancy, master-slave context, for commercial gain so long as applicable privacy laws, compliance and customer experience goals are met and each participating business can retain control over its data in slave views of its system, e.g., for commercial, privacy, legal, compliance and customer-experience reasons. Multi-tenancy might be used to offer marketing as a service at lower hosting and operational costs.

FIG. 7 is a schematic illustration of an embodiment of a privacy compliant, distributed customer relationship management (CRM) network where Business A wishes to license its system and data to Business-B or any number of businesses, in a peer-peer context, for commercial gain so long as applicable privacy laws, compliance and customer experience goals are met and retain control over their data in slave views of their system for commercial, privacy, legal, compliance and customer experience reasons. In this embodiment certain services such as the Communication Proxy, the Application API service, the Campaign Management System, the Content Generation Engine and the Content Management System can be greyed simply to highlight the addition of the Peer to Peer API Service (204) and how it interacts acts with the Secure Data Transfer Layer, the Master and Slave CRM systems and the Business Intelligence/Propensity Modelling System. The Marketing as a Service App (100) and the Customers (500) are present in this embodiment but not shown for reasons of diagram clarity.

FIG. 8 shows a block diagram of a computing environment suitable for use in combination with technology examples described herein.

### DETAILED DESCRIPTION

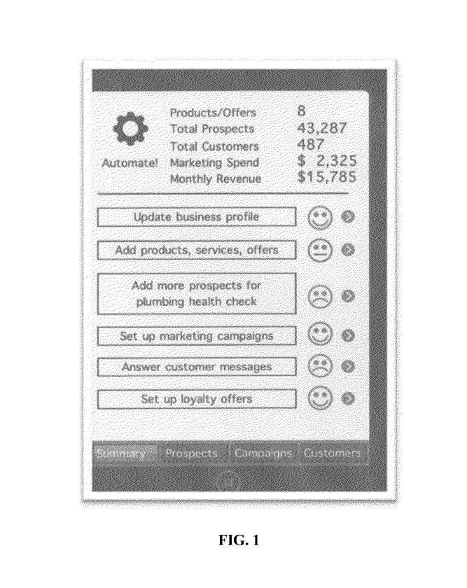

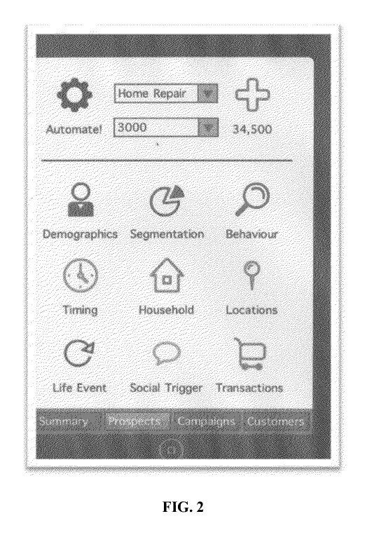

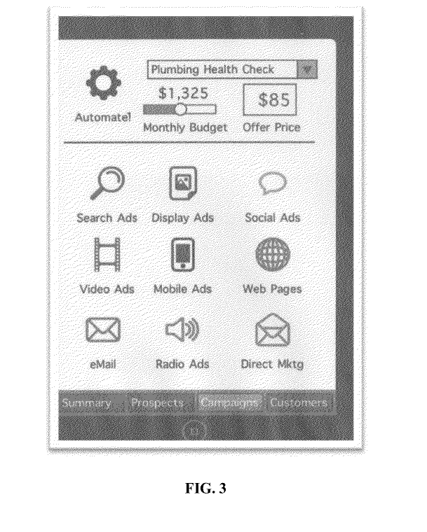

A simplified, integrated customer, prospect and campaign management system, the user interface of which is shown in FIGS. 1 to 4, abstracts and conceals the deeper operating complexity of such marketing systems as described in the embodiments below with respect to the diagrams 5 to 7.

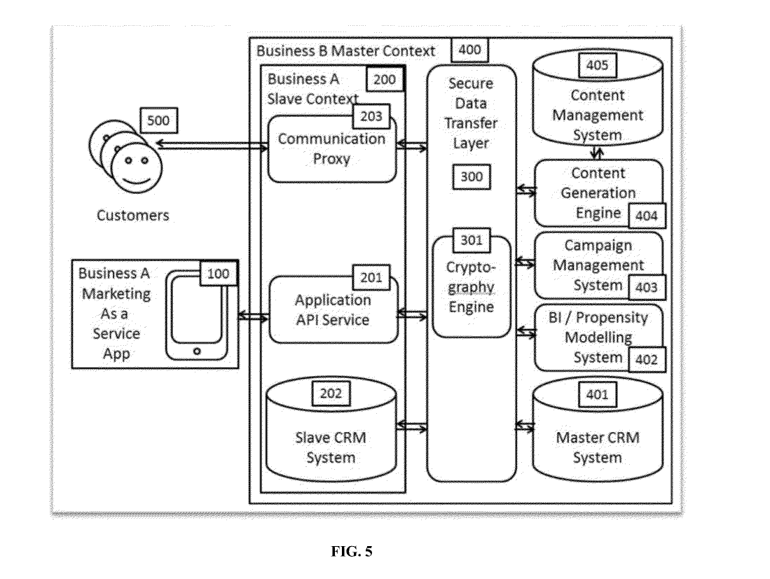

A distributed multi-master CRM and multi-slave CRM and peer-peer CRM, as shown in FIGS. 5 to 7, includes an application server operatively coupled to a database server, which in turn is configured to access data stored, in or among one or more of a wide variety of local or remote data stores, e.g., using network attached storage (NAS). As but one example, the application server can be a PC server, of the type provided by Amazon Web Services, IBM Corporation or Salesforce, running Tomcat by Apache or Node.js, on RedHat Linux. The application server can include a plurality of server components, as shown in FIG. 5, including a, cryptographic engine, a content generation engine, and a data access layer for managing the communication of data between or among other parts of the system, for example, the database server and content generation server. The application server can be designed to integrate with purpose built or pre-existing CRM Systems such as Salesforce, Oracle Siebel, SugarCRM or Microsoft Dynamics. The application server can be designed to integrate with purpose built or pre-existing propensity modelling systems such as SAS Enterprise Business Intelligence Suite or IBM's SPSS Modeller. The application server can be designed to integrate with purpose built or pre-existing Campaign management systems such as IBM Unica or SAS Business Intelligence Suite. Third party marketing communication tools such as Salesforce's BuddyMedia, Google's DART for Agencies, Google's BidManager, Responsys's marketing suite, Kenshoo's marketing suite or APIs including those offered by Google, Facebook and Twitter may be utilised by the communication proxy to deliver content generated in the content generation engine and selected and scheduled by the campaign management system. The application server also provides a number of client components for access and execution on one or more client computers that connect locally or remotely (e.g., via the Internet) to the application server. A client computer can be a tablet computer, for example available from Samsung Ltd, a computer available from Apple Corporation and running Mac OS X, or any of various other configurations of computing devices (e.g., smart phones, desktops, laptops, ultrabooks). The client components can include an allocation tool, a content creation wizard, an approvals client and a data loader for communicating respectively with the cryptographic engine, the content creation engine, and the data access layer of the application server. The client components can provide suitable interfaces of the system to generate the interface displays on a client computer. The client components can be processed by a web browser running on the client computer, such that the displays are generated within the web browser and no installation process is required on the client machine. The web browser may be any suitable browser, e.g., a browser that supports HTML5, such as Firefox, Google Chrome, Safari by Apple Corporation, or Internet Explorer by Microsoft.

The embodiment shown in FIG. 5 includes a mechanism for a client application, Business-A Marketing as a Service App (100), to request a series of next best actions for their business to market their products. Such actions may include completing their business profile, purchasing more prospects, converting existing prospects in their CRM system into customers, replying to customer messages, taking actions to improve the loyalty status of existing customers, monitoring existing marketing balance and spend or monitoring revenue.

In each case a Business-A operating the Marketing as a Service App (100) may make a series of client side API calls to the Application API Service (201) that forms part of the Business-A Slave Context (200) application provided by Business-B. The Application API Service (201) can utilise a Secure Data Transfer Layer (300), e.g., secured by the Cryptography engine (301), to transfer information securely and privately from one or more of the Master CRM System (401), the Business Intelligence/Propensity Modelling System (402), the Campaign Management System (403), and the Content Generation Engine (404) in the Business-B Master Context (400) to the Slave CRM System (202) or the Communication Proxy (203) in the Business-A Slave Context (200) and thence to the Business-A Marketing as a Service App (100) for client side decisions and management or to Customers (500) utilising online, mobile/tablet, video/IPTV, social media, Computer Telephony Integration (CTI), email, direct mail etc for marketing or service communications.

Within the embodiment described in FIG. 5, a Business-A operating the Marketing as a Service App (100) may register or define a business within a certain business category, principal keywords, set of postcode/zip code service areas and/or hours of operation. Such an operation can involve a series of client side API calls to the Application API Service (201) within the Business-A Slave Context (200) application provided by Business-B. The Application API Service (201) utilises the Secure Data Transfer Layer (300), secured by the Cryptography engine (301) to transfer the registration information with respect to Business-A securely and privately to the Master CRM System (401) for storage. Confirmation of the successful registration of Business-A is returned to the Business-A Marketing as a Service App (100) via the Application API Service (201) within the Business-A Slave Context (200) application provided by Business-B.

Within the embodiment described in FIG. 5, a Business-A operating the Marketing as a Service App (100) may define a product or service for offer or sale within a certain business category, principal keywords, set of postcode/zip code service areas and/or hours of operation. Such a product might be an item for sale by bricks and mortar store or via e-Commerce or a consumable item such as found in a cafė, bar, restaurant, nightclub, etc. Such a service might be a trade or professional service such as gardening service, plumbing services, concreting services, conveyancing services, mortgage services, book keeping services, pest control services, removalist services, adult entertainment services etc. Such products or services, as defined, may include text, image, video, price, action designations, design templates, colour palettes and/or terms and conditions descriptors for the given product or service. Such an operation involves a series of client side API calls to the Application API Service (201) within the Business-A Slave Context (200) application provided by Business-B. The Application API Service (201) utilises the Secure Data Transfer Layer (300), secured by the Cryptography engine (301) to transfer the product registration information with respect to the product or service set of Business-A securely and privately to the Master CRM System (401) for storage. Confirmation of the successful registration of Business-A's product or service is returned to the Business-A Marketing as a Service App (100) via the Application API Service (201) within the Business-A Slave Context (200) application provided by Business-B.

Within the embodiment described in FIG. 5, a Business-B operating a Master Context (400) may utilise information recorded in the Master CRM System (401) over time in conjunction with the Business Intelligence/Propensity Modelling System (402) to generate a list of prospects that fit various business categories, products, services or segments with a high propensity for purchase or uptake. By way of example, if a customer registers to sell their home with an online real estate listing company then it is likely that that customer will also soon look to buy another property. This information provides a propensity for interest in services such as conveyancing, real estate purchase, removalist services, building services, landscaping services, gardening services, cleaning services etc. As but one particular, but not exclusive example, by comparing transactions in numerous businesses that license slave contexts, Business-B can reverse engineer propensity models and causal chains of events. Over a period of operation scores and weights may be determined for building customer rankings for interest in various services and products offered within a number of slave business contexts. Completing a transaction in one business's sales lifecycle funnel may provide a trigger to commence a customer as a prospect in one or more other business's sales lifecycle funnels for a given products or services. Customer histories may be repeatedly analysed and compared within the Business Intelligence/Propensity Modelling System (402) within the Master Context (400) and chains of causal products and services continually refined and perfected.

Within the embodiment shown in FIG. 5, propensity models may be built within the Business Intelligence/Propensity Modelling System (402) using a range of extensional and intensional systems. Extensional systems while semantically clumsy can be computationally simple dealing with uncertainty in a context free manner. Extensional systems treat uncertainty as a truth value attached to logic rules. For instance, if an extensional system has a rule A implies B and the system observes A then the embodiment will infer something about the state of B regardless of any other knowledge available to it. If an intensional system were to deal with the same rule it would interpret the rule as a probability expression P(B|A)=p. What the embodiment believes about B in this system is dependent on our whole view of the problem and how all the available information interacts. Even the embodiment has full value of A the only thing the system may know to be relevant about B is that the probability of B is some value p where 0<=p<=1. When the embodiment discovers new knowledge, K, an intensional system revokes its previous knowledge about B and calculates P(B|A n K)=q. Both Extensional and Intensional systems are limited in that they require a learning mechanism to detect the relevance relationships between variables in their domain.

Within the embodiment described in FIG. 5, Bayesian networks may be used as a mechanism for developing the relevance relationships between variables in a given product or service domain. Such networks can be coded as acyclic graphs in which the nodes represent stochastic variables. The directed arcs within the structure represent probabilistic relationships between variables. Each root node within a Bayesian network is allocated a prior probability to each of its states. Each other node in the network has a conditional probability matrix representing probabilities for that variable conditioned on the value of its parent nodes. Instantiation of the Bayesian network leads to a propagation of probabilities through the network to give posterior beliefs about the states of the variables represented by the graph. In utilising Bayesian networks the embodiment of the Business Intelligence/Propensity Modelling System (402) seeks to provide a computational model for intelligent reasoning and a coherent account of how beliefs should change in the light of partial or uncertain knowledge. Such a system is perfect when a domain and it's probabilities are well understood or there is enough time and data available to develop and train a meaningful network structures, priors and conditional probability matrices.

Within the embodiment described in FIG. 5, propensity models may be built within the Business Intelligence/Propensity Modelling System (402) utilising unsupervised learning algorithms such as Minimum Message Length based on modelling based around data compression and encoding based on, for example, Shannon's mathematical theory of computation and first proposed by Wallace and Boulton in 1968. Such a modelling technique seeks to define the best model for a set of data by attempting to communicate that data in the minimal encoded length. The overall message length can be calculated by adding the bit length of the describing model to the bit length of the encoded data. The model that defines the shortest total message can be deemed to be the best model to describe the data. This can provide a means to classify the data into encoding models. Such an algorithm does not require any knowledge of a particular domain to operate. It simply can have the data fields, formats and ranges of values defined. Once a suitable model is derived an expert or other person knowledgeable in the art (e.g., one of ordinary skill in the art) can apply logical names based on the domain to the classification segments. Such a technique may be capable of uncovering propensity models that beyond the logic or reasoning of a trained observer in the field.

Within the embodiment shown in FIG. 5, propensity models may be built within the Business Intelligence/Propensity Modelling System (402) by a combination of one or more techniques described herein and may be combined by weighting and scoring algorithm into a prioritised list of models by customer and/or by prospect.

With an embodiment shown in FIG. 5, a Business-A operating the Marketing as a Service App (100) may request prospects for a given product or service within a certain business category, principal keywords, set of postcode/zip code service areas and/or hours of operation. Prospects so requested may be requested within bounds defined by but limited to demographics such as age, gender, ethnicity, religion, sexual and/or political preference etc., segmentation including Collage, Montage, Mosaic, Vignette segmentation etc, household specifics including income, census district, rent/own, home/unit, new mover etc., location whether being home, work, search or current roaming location etc., life events such as births, deaths, marriages etc., social structures such as friends, friends of friends, relations, social triggers such as friendship declaration, breakups, parties, social gatherings etc., and transactions such as products or services purchases, renewals, changes of brand loyalty etc., as well as a wide range of other classifications. Such an operation can involve a series of client side API calls to the Application API Service (201) within the Business-A Slave Context (200) application provided by Business-B. For example, the Application API Service (201) can use the Secure Data Transfer Layer (300) to make calls to the Business Intelligence/Propensity Modelling System (402) which can be used to identify customers within the Master CRM System (401) that fit a segment with a high propensity for the given product or service. The Campaign Management System (403) can be used to select a subset of the customers within the target segment taking into account business rule, contact rules & any opt out cases. Each customer record selected from the Master CRM System (401) may be provided as an anonymous prospect to the Slave CRM System (202) by stripping out all personally identifiable information from the CRM record and applying a salted one way cryptographic hashing algorithm, such as, by way of example, a SHA-1 hash or similar algorithm, to a combination of one or more identifying key fields such as but not limited to the CRM primary key or record identifier, a customer's existing or relevant product holding primary key or record identifier, a system session primary key or record identifier within the Cryptography engine (301) within the Secure Data Transfer Layer (300). The salt selected in such an embodiment may use one or more identifying key fields of Business-A as part of the salting algorithm, such as but not limited to Business-A's primary key or record identifier, Business-A's relevant product offering primary key or record identifier, a system session primary key or record identifier. This allows each one-way hash to be unique to the context of a precise customer and slave business context on a session by session or engagement by engagement basis. To further secure this process, the system supports individual submission and management of an additional salt seed contribution by each Business-B. This mechanism can prevent collusion between businesses or even a single businesses executing repeat engagements to mine the data of Business-B. At any time in the future the Master CRM System (401) source may be used to identify a prospect within the Slave CRM System (202) by either recording the one-way hash within the Business-B Master Context (400) or by rerunning the hash algorithm. Obviously from a review of this disclosure, the former method can be much quicker however territorial privacy compliance may necessitate the later method. Either way a recording of either multiple anonymous prospect identifiers to customer identifiers is stored or the fields used to create the identifier are recorded against the customer identifier in the Master CRM System (401) as this allows for deducing and reconciling reporting data both within the Master CRM System (401) either for the Master CRM System (401) or on behalf of Business-A or Business-B for both performance and invoicing purposes. Depending on the nature of the commercial relationship between business-A and Business-B, more or less information about prospects may be made available in the Slave CRM System (202). Where a tangible lead is created the prospect may be partially or fully identified by matching records between the Master CRM System (401) and the Slave CRM System (202) within the Business-B Master Context (400) and updating or augmenting the information within the Slave CRM System (202) within the Business-A Slave Context (200).

An anonymous prospect record accessible within the Slave CRM System (202) may optionally include one or more of the following information:
a) A one-way hash based on an identifier within the Master CRM System (401), such a hash being unique to Business-A for the given prospect
b) A set of relevant products or services the prospect is selected for
c) A set of numerical positions within a funnel denoting the prospect's current sales lifecycle positions with respect to the set of nominated products or services

Other data can be kept within the Business-B Master Context (400) until such time as the prospect is be partially or fully identified by reaching a certain position within the sales lifecycle where identification is warranted or when the prospect consents to be identified to Business-A.

When an anonymous prospect record becomes identified within the Slave CRM System (202) it may optionally include any of but not limited to the following information:
a) A one-way hash based on an identifier within the Master CRM System (401), such a hash being unique to Business-A for the given prospect
b) A set of relevant products or services the prospect is selected for
c) A set of numerical positions and transaction outcomes within a funnel denoting the prospect's full sales lifecycle history with respect to the Business-A and the set of nominated products or services
d) The full name of the customer including any relevant title
e) The age of the customer
f) The birth date of the customer
g) The gender of the customer
h) Marital or partner status of the customer
i) Names, numbers and ages of any dependents
j) Names, numbers, species and ages of any pets
k) Household income of the customer
l) A set of home or billing addresses of the customer, past and present
m) A set of postal or billing addresses of the customer, past and present
n) A set of work addresses of the customer, past and present
o) A set of employers of the customer, past and present
p) A set of titles or positions held within those employments
q) A set of relevant industry code or business categories of employers
r) A set of purchase authorities held within those employers
s) A set of head counts managed within those employers
t) A set of communication histories with respect to the Business-A and the set of nominated products or services
u) And so on, and so forth

In the embodiment shown in FIG. 5, a Business-A operating the Marketing as a Service App (100) may request marketing communications be generated and sent for a given product or service within a certain media mix and to a given set of prospects or customers. Such an operation can involve a series of client side API calls to the Application API Service (201) within the Business-A Slave Context (200) application provided by Business-B. The Application API Service (201) can use the Secure Data Transfer Layer (300) to make calls to the Campaign Management System (403) which can be used to select, for example, an appropriate set of marketing channels taking into account the target segment, any business rules, contact rules & any opt out cases. Target entries within the Slave CRM System (202) can be matched to record within the Master CRM System (401) within the Master Context (400) by either looking up any stored one-way hash mapping table within the Business-B Master Context (400) or by rerunning the hash algorithm within the Cryptography engine (301) within the Secure Data Transfer Layer (300). The Content Generation Engine (404) can use stored product or service text, image, video, price, action designations, design templates, colour palettes and/or terms and conditions descriptors to generate a variety of messages appropriate to the channels nominated by the Campaign Management System (403). The Communication Proxy (203) in the Business-A Slave Context (200) can communicate with Customers (500) utilising online, mobile/tablet, video/IPTV, social media, Computer Telephony Integration (CTI), email, direct mail etc as communication channels. In some embodiments, each and every impression, click, action, transaction etc., can be recorded back against both the Slave CRM System (202) within the Business-A Slave Context (200) and the Master CRM System (401) within the Master Context (400). Where a tangible interaction occurs, the prospect may be advanced within the sales funnel for the given product or service and partially or fully identified by matching records between the Master CRM System (401) and the Slave CRM System (202) within the Business-B Master Context (400) and updating or augmenting the information within the Slave CRM System (202) within the Business-A Slave Context (200).

Within the embodiment shown in FIG. 5, a Business-A operating the Marketing as a Service App (100) may request access to or respond to messages received from any given anonymous prospect or known customer. Such an operation can involve a series of client side API calls to the Application API Service (201) within the Business-A Slave Context (200) application provided by Business-B. The Application API Service (201) can use the Secure Data Transfer Layer (300) to make calls to the Communication Proxy (203) in the Business-A Slave Context (200) which may from time to time receive communications from target prospects or customers. Such communications while within the Business-A Slave Context (200) can be visible only through the Application API Service (201) and thus can actually remain under the control of the Master Context (400). In some embodiments, Business-A never directly communicates with the prospects (500) but always utilises the Communication Proxy (203). Even when identified, it can be advantageous for Business-A to continue to use the Marketing as a Service App (100) and therefore the Application API Service (201) and Communication Proxy (203) as it keeps all prospects and customers within a single funnel view for them. All communications, whether to anonymous prospects or unidentified or anonymous customers, can be stored against both the Slave CRM System (202) within the Business-A Slave Context (200) and the Master CRM System (401) within the Master Context (400). A Business-A operating the Marketing as a Service App (100) can view such communications and reply to them via the Communication Proxy (203) in the Business-A Slave Context (200). The Communication Proxy (203) in the Business-A Slave Context (200) can communicate with prospects or Customers (500) utilising online, mobile/tablet, video/IPTV, social media, Computer Telephony Integration (CTI), email, direct mail etc., for example, as described in the previous paragraph. All communications both incoming and outgoing can be stored within the Master CRM System (401) and can be referenced by the Slave CRM System (202), in some instances only while the customer remains either a prospect or a customer of Business-A.

Within the embodiment shown in FIG. 5, a Business-A operating the Marketing as a Service App (100) may request a total marketing spend on a given product across all media per calendar month. Such an operation can involve a series of client side API calls to the Application API Service (201) within the Business-A Slave Context (200) application provided by Business-B. The Application API Service (201) can use the Secure Data Transfer Layer (300) to make calls to the Campaign Management System (403) which can be used to calculate the total media spend for all marketing communications with respect to the requested business, product or service and said information cam be returned to the Marketing as a Service App (100).

Within the embodiment shown in FIG. 5, a Business-A operating the Marketing as a Service App (100) may request a total revenue generated by a given product per calendar month. Such an operation can involves a series of client side API calls to the Application API Service (201) within the Business-A Slave Context (200) application provided by Business-B. The Application API Service (201) can use the Secure Data Transfer Layer (300) to make calls to the Master CRM System (401) within the Master Context (400) which can calculate the total conversions and revenue generated with respect to the requested business, product or service and said information can be returned to the Marketing as a Service App (100).

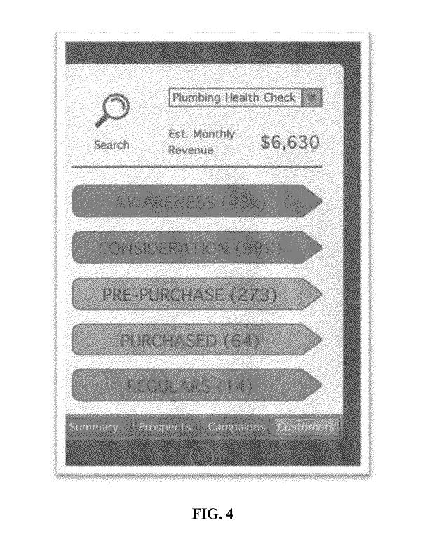

Within the embodiment shown in FIG. 5, a Business-A operating the Marketing as a Service App (100) can request to view all prospects and customers currently visible within their business or to a single product as a single funnel view. Such a funnel may include a fully customisable number of named tiers, by way of example this may include: Awareness, Consideration, Pre-purchase, Purchase and Regulars, as shown in FIG. 4, or another example of this embodiment is Reach, Interest, Desire, Conversion, Enrichment & Loyalty etc. Funnel entries within the Slave CRM System (202) can be matched to records within the Master CRM System (401) within the Master Context (400), for example, by either looking up any stored one-way hash mapping table within the Business-B Master Context (400) or by rerunning the hash algorithm within the Cryptography engine (301) within the Secure Data Transfer Layer (300).

Within the embodiment shown in FIG. 5, calls to the Application API Service (201) can be made by RESTful calls and pass and receive JSON messages. In some embodiments, Business-A may either utilise the Marketing as a Service App (100) or apply for a secure access token and cryptographic secret and construct their own application utilising the Application API Service (201).

By way of example, an indicative set of calls to the API is listed below (this is clearly not an exhaustive list):
GET https://<hostname>:<port>/products/<timestamp>/<authToken>(Gets a list of products or services for the authenticating business)
GET https://<hostname>:<port>/productsktimestamp>kauthToken>kid>(Gets the identified product or service for the authenticating business)
POST https://<hostname>:<port>/products/<timestamp>/<authToken>(Creates a product or service for the authenticating business)
PUT https://<hostname>:<port>/productsktimestamp>kauthToken>kid>(Updates the identified product or service for the authenticating business)
DEL https://<hostname>:<port>/productsktimestamp>kauthToken>kid>(Deletes the identified product or service for the authenticating business)
   The <authToken>can be a token constructed by the client and is a one way hash of the supplied authentication token salted with a timestamp and a shared secret known by both Business-A and Business-B.
   Information relating to a product or service or other object being created or edited can be passed within JSON data associated with the POST or PUT method calls. By way of example an embodiment of a product object, an identified customer object and an anonymous prospect object are provided. (Clearly this is not an exhaustive list of objects within the embodiment.)
   An example anonymous prospect JSON object:

```
{
  “id”: “07e82cd00f58b2cc0a4648d7e38715a8168c570f”,
  “products”: [
    {
      “productId”: “34cfdc11717ebe5856a8869a71f08e0c88b4c991”,
      “funnelPosition”: 1,
    },
    {
      “productId ”: “9bac52d80961ca4c91bb86056d7256ed5faa7011”,
      “funnelPosition ”: 3,
    }
  ]
}
```

An example identified customer JSON object:

```
{
  “id”: “07e82cd00f58b2cc0a4648d7e38715a8168c570f”,
  “products”: [
    {
      “productId”: “34cfdc11717ebe5856a8869a71f08e0c88b4c991”,
      “funnelPosition”: 1,
    },
    {
      “productId ”: “9bac52d80961ca4c91bb86056d7256ed5faa7011”,
      “funnelPosition ”: 3,
    }
  ]
  “firstName”: “Jane”,
  “lastName”: “Doe”,
  “age”: 41,
  “gender”: F,
  “address”: [
    {
      “type”: “home”,
      “streetAddress”: “Kirribilli House”,
      “city”: “ Kirribilli”,
      “state”: “NSW”,
      “country”: “AU”,
      “postalCode”: “2061”
    }
  ],
  “phoneNumber”: [
    {
      “type”: “home”,
      “number”: “+612 6277 7700 ”
    },
    {
      “type”: “fax”,
      “number”: “+612 6273 4100”
    }
  ]
}
```

An example product JSON object:

```
{
  “id”: “84f262f1402f84885b0754e448a24eff1e8e8222”,
  “productName”: “plumbing health check”,
  “category”: “plumbing”,
  “keyword”: [
    “exact”: “ plumbing”,
    “phrase”: “ plumbing health check”,
    “phrase ”: “ water heater”,
    “exact ”: “ plumber”,
    “phrase ”: “ gas water heater”,
    “broad ”: “ toilet repair”
  ],
  “location”: [
    {
      “postalCode”: “2061”,
      “areaRadius”: 5,
    },
  ]
  “hours”: [
    {
      “day”: “Monday”,
      “start”: 0800,
      “end”: 1800,
      “zone”: “+10”
    },
    : // ellided
    {
      “day”: “Friday”,
      “start”: 0800,
      “end”: 1800,
      “zone”: “+10”
    }
  ]
}
```

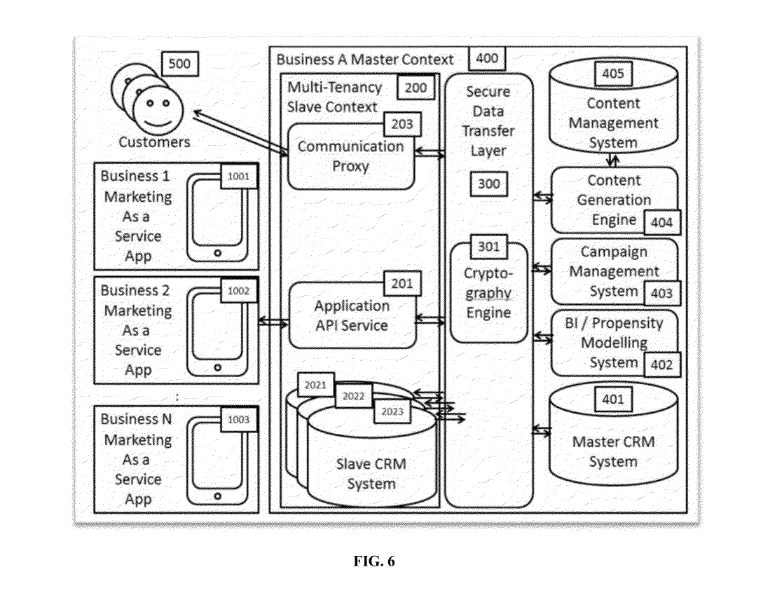

The embodiment shown in FIG. 6 can operate as per the embodiment described in FIG. 5 with the exception that the embodiment shown in FIG. 6 can include a mechanism for multiple businesses to operate separate client applications, e.g., Marketing as a Service Apps (1001, 1002 & 1003 and so on), to request a series of next best actions for their individual businesses to market their respective products. Such actions can include completing their business profile, purchasing more prospects, converting existing prospects in their CRM system into customers, replying to customer messages, taking actions to improve the loyalty status of existing customers, monitoring existing marketing balance and spend or monitoring revenue.

In each case, each business operating its Marketing as a Service App (1001, 1002 & 1003 respectively) may make a series of client side API calls to the Application API Service (201) that forms part of the Business-A Slave Context (200) application provided by Business-B. The Application API Service (201) can use the Secure Data Transfer Layer (300), secured by the Cryptography engine (301) to transfer information securely and privately from the Master CRM System (401), the Business Intelligence/Propensity Modelling System (402), the Campaign Management System (403), and/or the Content Generation Engine (404) in the Business-B Master Context (400) to their respective Slave CRM Systems (2021, 2022 & 2023 respectively) held in shared tenancy or the Communication Proxy (203) in the shared tenancy Slave Context (200) and thence to each business's Marketing as a Service App (1001, 1002 & 1003 respectively) for client side decisions and management or to Customers (500) utilising online, mobile/tablet, video/IPTV, social media, Computer Telephony Integration (CTI), email, direct mail etc for marketing or service communications.

Within the embodiment shown in FIG. 6, each business operating the Marketing as a Service App (1001, 1002 & 1003 respectively) can be allocated, for example, uniquely identified prospect and customer ids even though each of these records may be referenced from a single customer record within the Master CRM System (401) within the Master Context (400). To achieve the unique id, a combination of one or more identifying key fields such as but not limited to the CRM primary key or record identifier, a customer's existing or relevant product holding primary key or record identifier, a system session primary key or record identifier within the Cryptography engine (301) within the Secure Data Transfer Layer (300). The salt selected in such an embodiment may use one or more identifying key fields of Business-A as part of the salting algorithm, such as but not limited to Business-A's primary key or record identifier, Business-A's relevant product offering primary key or record identifier, a system session primary key or record identifier. This allows each one-way hash to be unique to the context of a precise customer and slave business context on a session by session or engagement by engagement basis. To further secure this process, the system supports individual submission and management of additional salt seed contribution by each slave business. This can be more important in the case of anonymous prospects and can be designed to prevent collusion and data mining of anonymous records between complicit businesses. Without such a mechanism, a business with an identified customer record might be able to data match with a business who holds identified customer records. Such matching might not only be considered a breach of privacy in certain jurisdictions but also could prevent the master business from deriving a full commercial benefit from being a central point of dependency.

Within the embodiment shown in FIG. 6, the multiple businesses might instead choose not to operate within a shared tenancy model. In such cases, the operation could be more similar to the embodiment described in FIG. 5 however the independent identification mechanism described above can persist to protect prospects and customer's data and privacy.

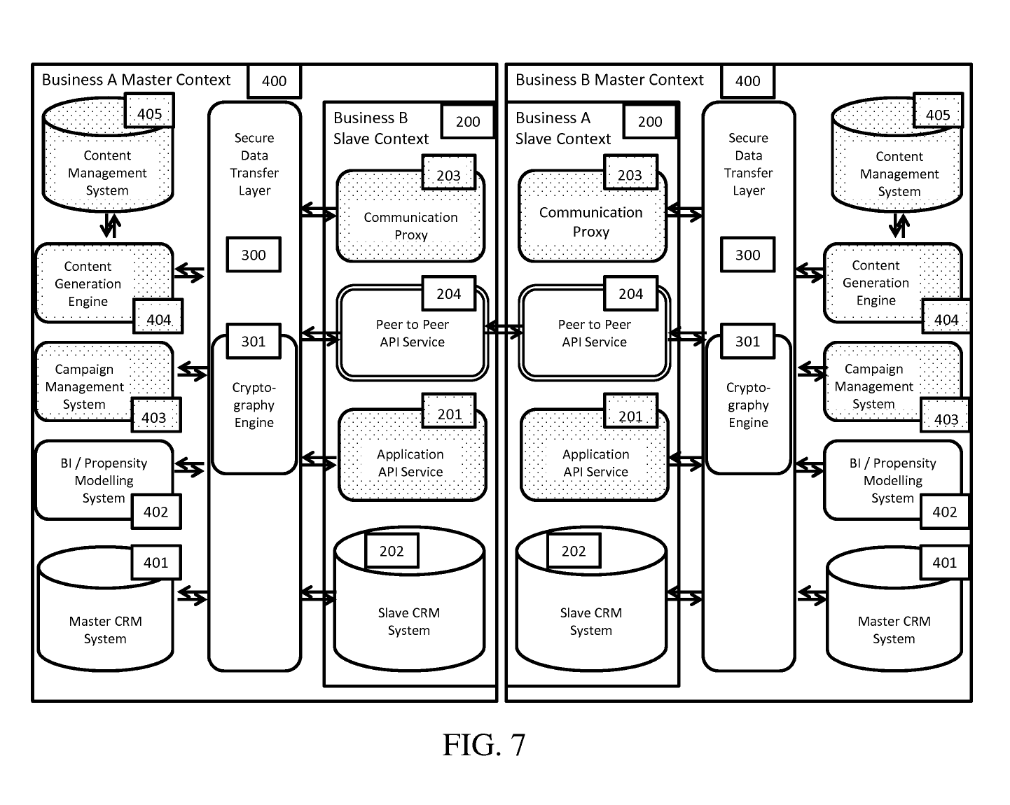

The embodiment shown in FIG. 7 can operate as per the embodiment described in FIG. 5 with the exception that Business-A may license their system and data to Business-B or any number of businesses, in a peer-peer context, for commercial gain so long as applicable privacy laws, compliance and customer experience goals are met and retain control over their data in slave views of their system for commercial, privacy, legal, compliance and customer experience reasons. In this embodiment the Peer to Peer API Service (204) allows each business to utilise models created in each other's Business Intelligence/Propensity Modelling System (402) within their respective Master Contexts (400) and market to each other's customers from their respective Master CRM Systems (401) but in an anonymous manner through each other's the Secure Data Transfer Layer (300), their Slave CRM Systems (202) and their respective Communication Proxies (203).

The embodiment shown in FIG. 7 can call to the Peer to Peer API Service (204) as an equivalent manner as in the Application API Service (201). Information can be requested by RESTful calls and passes and receives JSON messages. Businesses may use secure access tokens and/or cryptographic secrets, for example, to communicate with one another over the Peer to Peer API Service (204). Each business can remain in control of when it identifies anonymous prospects to another business and the method of identification can be identical to that described above in connection with FIG. 5 above.

Within the embodiment described in relation to FIG. 5, FIG. 6, or both, viable revenue models for operation can include but are not limited to a Business operating a Master Context (400) offering a Marketing as a Service App (100) to one or more businesses as independent or multi-tenancy Slave Contexts (200). The Marketing as a Service App and the Application Server instance may be offered at a fixed dollar cost per month. The participating slave businesses may be offered a cost per communication sent or delivered model. The participating slave businesses may be offered a cost per communication interaction model, for example, cost per click. The participating slave businesses may be offered a cost per prospect or cost per lead model. The participating slave businesses may be offered a cost per order or cost per acquisition model.

Within the embodiment shown in FIG. 7, viable revenue models for operation can include but are not limited to a fixed license cost per month to allow each business to exchange prospects and or leads and or identify customers. The participating peer businesses may be offered a variable license fee based on cost per communication, interaction, prospect, lead, order or acquisition models.

In each of embodiments described in relation to FIGS. 5 to 7, an over-arching master business may be retained to act as a trusted intermediary and manager as a service of a marketing data market place. This secure, trusted and privacy compliant master business may also obtain revenue by appending and reporting on tracking code for marketing actions and handling transactions, billing, payments and updating business accounts and general ledgers.

Computing Environments

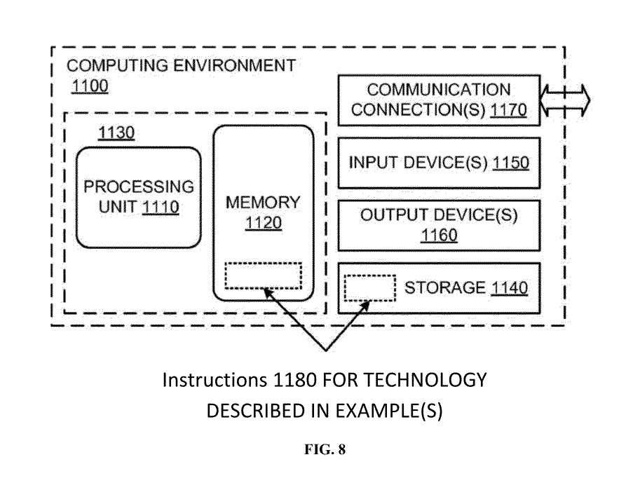

FIG. 8 illustrates a generalized example of a suitable computing environment 1100 in which described methods, embodiments, techniques, and technologies may be implemented. The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 8, the computing environment 1100 includes at least one central processing unit 1110 and memory 1120. In FIG. 8, this most basic configuration 1130 is included within a dashed line. The central processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software or other instructions 1180 that can, for example, implement one or more of the innovative technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and which can be accessed within the computing environment 1100. The storage 1140 stores instructions for the software or other instructions 1180, which can implement technologies described herein.

The input device(s) 1150 may be a touch input device, such as a keyboard, keypad, mouse, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, or other data. The information can pertain to a physical parameter observed by a sensor or pertaining to a command issued by a controller, e.g., to invoke a change in an operation of a component in the system 10 (FIG. 1).

Computer-readable media are any available media that can be accessed within a computing environment 1100. By way of example, and not limitation, with the computing environment 1100, computer-readable media include memory 1120, storage 1140, communication media (not shown), and combinations of any of the above.

Other Exemplary Embodiments

The examples described herein generally concern improved CRM. Other embodiments than those described above in detail are contemplated based on the principles disclosed herein, together with any attendant changes in configurations of the respective apparatus and changes in logic flow described herein. Incorporating the principles disclosed herein, it is possible to provide a wide variety of improved CRM systems.

Directions and references (e.g., up, down, top, bottom, left, right, rearward, forward, etc.) may be used to facilitate discussion of the drawings but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by references in its entirety for all purposes.

The principles described above in connection with any particular example can be combined with the principles described in connection with any one or more of the other examples. Accordingly, this detailed description shall not be construed in a limiting sense, and following a review of this disclosure, those of ordinary skill in the art will appreciate the wide variety of CRM and other systems that can be devised using the various concepts described herein. Moreover, those of ordinary skill in the art will appreciate that the exemplary embodiments disclosed herein can be adapted to various configurations without departing from the disclosed principles.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

Thus, in view of the many possible embodiments to which the disclosed principles can be applied, it should be recognized that the above-described embodiments are only examples and should not be taken as limiting in scope. I therefore reserve all rights to the subject matter disclosed herein, including the right to claim all that comes within the scope and spirit of the following claims, as well as all aspects of any innovation shown or described herein.

I presently claim:

1. A method of managing customer relationship information, the method comprising:
accessing one or more customer relationship data records stored in or on a database, wherein each record includes private information and information pertaining to a state in a sales funnel;
masking or otherwise rendering anonymous one or more aspects of the private information pertaining to each accessed one or more customer relationship data records;
transmitting the masked or otherwise anonymous one or more aspects of the private information and the corresponding information pertaining to a sales-funnel state to an intended recipient lacking authority to access the one or more aspects of the private information pertaining to each accessed one or more customer relationship data records.

2. A method of managing customer relationship information according to claim 1, further comprising associating each of the one or more accessed customer relationship data records with customer relationship information in another customer relationship management system.

3. A method of managing customer relationship information according to claim 2, wherein the act of associating comprises matching an anonymous system identifier assigned to the respective one or more accessed customer relationship data records to an identifier of a record in the other customer relationship management system.

4. A method of managing customer relationship information according to claim 3, wherein the identifier of a record in the other customer relationship management system corresponds, at least in part, to one or more of a registered third-party login identifier, a device identifier, an IP address on a time-window or access-time basis, a device fingerprint, and a behavioural context or profile.

5. A method according to claim 1, wherein the intended recipient comprises a peer or slave customer relationship management system.

6. A method according to claim 1, wherein the intended recipient comprises a plurality of intended recipients.

7. A method according to claim 1, wherein the act of transmitting further comprises transmitting a corresponding targeted information comprising one or more of a selected content, a sales-campaign information, and a measure of a customer's propensity for advancing in the sales funnel.

8. A method of obtaining customer relationship information in the absence of authority to receive private information corresponding to one or more aspects of the customer relationship information, the method comprising:
requesting one or more customer relationship data records stored in or on a database, wherein each record includes private information and information pertaining to a state in a sales funnel;
receiving, by a party lacking authority to receive at least a portion of the corresponding private information, at least one of the requested one or more customer relationship data records, wherein at least the portion of the corresponding private information has been masked or otherwise made anonymous, together with the corresponding information pertaining to a sales-funnel state.

9. A method of obtaining customer relationship information in the absence of authority to receive private information corresponding to one or more aspects of the customer relationship information according to claim 8, further comprising associating each of the one or more received customer relationship data records with customer relationship information in another customer relationship management system.

10. A method of obtaining customer relationship information in the absence of authority to receive private information corresponding to one or more aspects of the customer relationship information according to claim 9, wherein the act of associating comprises matching an anonymous system identifier assigned to the respective one or more received customer relationship data records to an identifier of a record in the other customer relationship management system.

11. A method of obtaining customer relationship information in the absence of authority to receive private information corresponding to one or more aspects of the customer relationship information according to claim 10, wherein the identifier of a record in the other customer relationship management system corresponds, at least in part, to one or more of a registered login identifier of the party lacking authority, a device identifier, an IP address on a time-window or access-time basis, a device fingerprint, and a behavioural context or profile.

12. A method of obtaining customer relationship information in the absence of authority to receive private information corresponding to one or more aspects of the customer relationship information according to claim 8, wherein the other customer relationship management system comprises a peer or slave customer relationship management system.

13. A method of obtaining customer relationship information in the absence of authority to receive private information corresponding to one or more aspects of the customer relationship information according to claim 8, wherein the party lacking authority comprises one of a plurality of intended recipients of the requested one or more customer relationship data records.

14. A method according to claim 8, wherein the act of receiving further comprises receiving a corresponding targeted information comprising one or more of a selected content, a sales-campaign information, and a measure of a customer's propensity for advancing in the sales funnel.

15. A customer relationship management system, comprising:
a plurality of customer relationship records, wherein each customer relationship record includes private information and information pertaining to a state in a sales funnel;
a cryptography engine configured to mask or otherwise render anonymous one or more aspects of the private information pertaining to the customer relationship data records;
a secure data transfer layer configured to receive requests from and to transmit to a requester lacking authority to access the one or more aspects of the private information the masked or otherwise anonymous one or more aspects of the private information and the corresponding information pertaining to a sales-funnel state.

16. A customer relationship management system according to claim 15, further comprising a tangible, non-transitory computer readable medium, wherein the plurality of customer relationship records is stored on the computer readable medium, and wherein the secure data transfer layer is further configured to access the stored customer relationship records.

17. A customer relationship management system according to claim 15, further comprising an allocator configured to associate each of the one or more accessed customer relationship data records with customer relationship information in another customer relationship management system.

18. A customer relationship management system according to claim 17, wherein the customer relationship management system is further configured to associate an anonymous system identifier assigned to the respective one or more accessed customer relationship data records to an identifier of a record in the other customer relationship management system.

19. A customer relationship management system according to claim 18, wherein the identifier of a record in the other customer relationship management system corresponds, at least in part, to one or more of a registered third-party login identifier, a device identifier, an IP address on a time-window or access-time basis, a device fingerprint, and a behavioural context or profile.

20. A customer relationship management system according to claim 15, wherein the requester lacking authority to access the one or more aspects of the private information comprises a peer or slave customer relationship management system.

21. A customer relationship management system according to claim 20, wherein the requester lacking authority to access the one or more aspects of the private information comprises a plurality of requesters lacking authority to access the one or more aspects of the private information.

22. A customer relationship management system according to claim 15, further comprising a data manager configured to track individual customer relationship management communications, target customer of said communications, and processing rules for determining a propensity model for future communications

23. A customer relationship management system according to claim 22, further comprising a content generation engine configured to process the customer relationship data records with a determined propensity model, wherein the content generation engine is configured to access content items and to generate one or more communication media for communication to a target customer at least partially on the basis of the propensity model.
